(19) United States
(12) Patent Application Publication
(10) Pub. No.: US 2022/0048305 A1
(43) Pub. Date: Feb. 17, 2022

(54) FABRIC PRINTABLE MEDIUM

(71) Applicant: Hewlett-Packard Development Company, L.P., Spring, TX (US)

(72) Inventors: Adam Weisman, San Diego, CA (US); Xiaoqi Zhou, San Diego, CA (US)

(21) Appl. No.: 17/047,308

(22) PCT Filed: May 31, 2018
(86) PCT No.: PCT/US2018/035301

§ 371 Date: Oct. 13, 2020

(51) Int. Cl. B41M 5/52; B41M 5/50; B41M 5/00; D06P 5/30; D06P 1/651; D06P 5/00; D06P 1/52

(52) U.S. Cl. CPC B41M 5/5227; B41M 5/508; B41M 5/0041; D06P 1/5221; D06P 1/65156; D06P 5/002; D06P 1/5285; D06P 5/30

(57) ABSTRACT

A fabric printable medium, with an image-side and a back-side, including a fabric base substrate; a primary layer containing polymeric binders applied on, at least, one side of the base substrate; and an image-receiving coating layer applied over, at least, one primary layer including a first and a second crosslinked polymeric network. The primary layer includes a flame-retardant dispersion including flame-retardant agents and polymeric dispersants. Also disclosed are the method for making such fabric printable medium and the method for producing printed images using said material.

### BACKGROUND

Inkjet printing technology has expanded its application to large format high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of medium substrates. Inkjet printing technology has found various applications on different substrates including, for examples, cellulose paper, metal, plastic, fabric and the like. The substrate plays a key role in the overall image quality and permanence of the printed images. Textile printing has various applications including the creation of signs, banners, artwork, apparel, wall coverings, window coverings, upholstery, pillows, blankets, flags, tote bags, etc. It is a growing and evolving area and is becoming a trend in the visual communication market. As the area of textile printing continues to grow and evolve, the demand for new printable mediums increases.

### BRIEF DESCRIPTION OF THE DRAWINGS

The drawings illustrate various examples of the present fabric printable medium and are part of the specification. FIG. 1, FIG. 2 and FIG. 3 are a cross-sectional view of the fabric printable medium according to some examples of the present disclosure.

FIG. 4 is a flowchart illustrating a method for producing the fabric printable medium according to one example of the present disclosure.

FIG. 5 is a flowchart illustrating a method for producing printed images according to one example of the present disclosure.

### DETAILED DESCRIPTION

Before particular examples of the present disclosure are disclosed and described, it is to be understood that the present disclosure is not limited to the particular process and materials disclosed herein. It is also to be understood that the terminology used herein is used for describing particular examples only and is not intended to be limiting, as the scope of protection will be defined by the claims and equivalents thereof. In describing and claiming the present article and method, the following terminology will be used: the singular forms “a”, “an”, and “the” include plural referents unless the context clearly dictates otherwise. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For examples, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percentages are by weight (wt %) unless otherwise indicated. As used herein, “image” refers to marks, signs, symbols, figures, indications, and/or appearances deposited upon a material or substrate with either visible or an invisible ink composition. Examples of an image can include characters, words, numbers, alphanumeric symbols, punctuation, text, lines, underlines, highlights, and the like.

When printing on fabric substrates, challenges exist due to the specific nature of fabric. Indeed, often, fabric does not accurately receive inks. Some fabrics, for instance, can be highly absorptive, diminishing color characteristics, while some synthetic fabrics can be crystalline, decreasing aqueous ink absorption leading to ink bleed. These characteristics result in the image quality on fabric being relatively low. Additionally, black optical density, color gamut, and sharpness of the printed images are often poor compared to images printed on cellulose paper or other media types. Durability, such as rubbing resistance, is another concern when printing on fabric, particularly when pigmented inks and ink compositions containing latex are used. To overcome these challenges, a functional coating, such as an image-receiving coating, is applied to the surface of the fabric substrate. However, since coating compositions contain some flammable substances such as polymeric binders, when such fabric printing media is intended to be used in close proximity to indoor environments (as drapes, as overhead signage, as part of furnishings, or the like), there are concerns about flame resistance as well as about using coatings that increase the flammability of the fabric. Thus, fire/flame resistance or inhibition characteristics of the coating compositions are also desirable when providing printable fabrics.

In one example, the present disclosure is drawn to fabric printable medium, with an image-side and a back-side, comprising a fabric base substrate; a primary layer containing polymeric binders applied on, at least, one side of the base substrate; and an image-receiving coating layer, applied over, at least one primary layer, comprising a first and a second crosslinked polymeric network; wherein the primary layer comprises a flame-retardant dispersion including a flame-retardant agents and polymeric dispersants. In some examples, both the primary layer and the image-receiving coating layer comprise a flame-retardant dispersion including flame-retardant agents and polymeric dispersants. The present disclosure also relates to a method for forming said fabric printable medium and to the printing method using said fabric printable medium.

The fabric printable medium, according to the present disclosure, is a printable recording medium (or printable media) that provide printed images that have outstanding print durability and excellent scratch resistance while maintaining good printing image quality (i.e. printing performance). In addition, the fabric printable medium has good flame resistance properties. By “scratch resistance”, it is meant herein that the composition is resistant to any modes of scratching which include, scuff and abrasion. By the term “scuff”, it is meant herein damages to a print due to dragging something blunt across it (like brushing fingertips along printed image). Scuffs do not usually remove colorant, but they do tend to change the gloss of the area that was scuffed. By the term “abrasion”, it is meant herein the damage to a print due to wearing, grinding or rubbing away due to friction. Abrasion is correlated with removal of colorant (i.e. with the OD loss). In some examples, the fabric printable medium described herein is a coated printable media that can be printed at speeds needed for commercial and other printers such as, for example, HP Latex printers such as 360, 560, 1500, 3200 and 3600 (HP Inc., Palo Alto, Calif., USA). The image printed on the fabric printable medium of the present disclosure exhibits excellent printing qualities and durability. By using coating compositions, in combination with fabric substrate, the printing process is more accurate, and the printed image is more permanent. The resultant printed fabric will also be able to provide fire/flame resistance or inhibition to the fabric. The present disclosure refers to a fabric printable medium comprising a fabric base substrate and coating compositions applied to said fabric base substrate. The coating compositions, also called treatment compositions, once applied on the fabric base substrate, are solidified and form thin layers onto the fabric base surface.

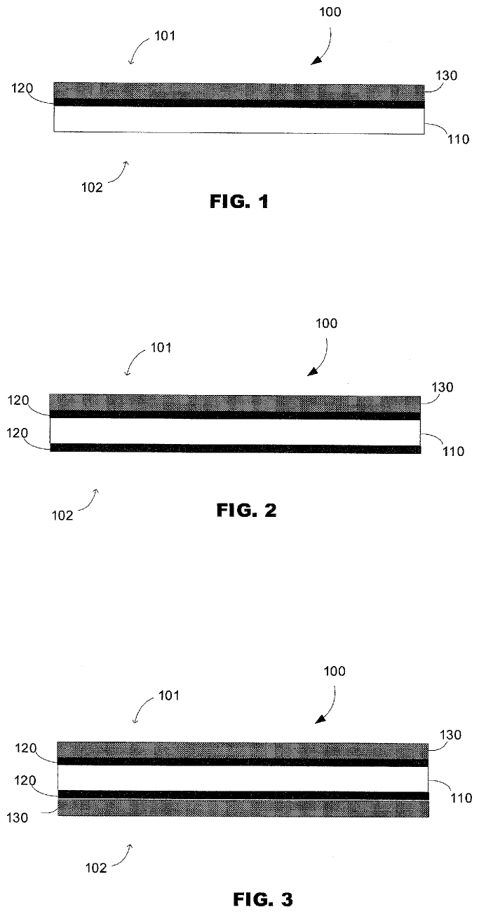

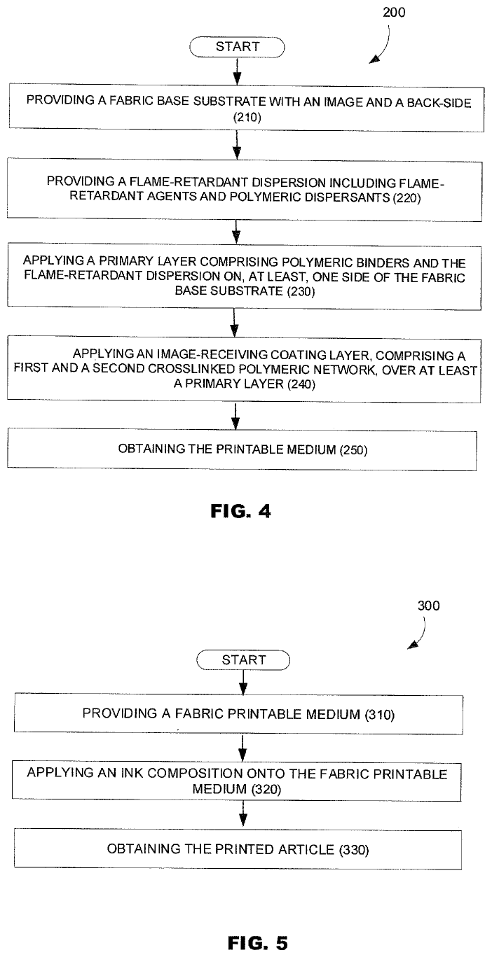

FIG. 1, FIG. 2 and FIG. 3 schematically illustrate some examples of the fabric printable medium (100) as described herein. FIG. 4 is a flowchart illustrating an example of a method for producing the fabric printable medium. FIG. 5 is a flowchart illustrating an example of printing method comprising obtaining a fabric printable medium as described therein and applying an ink composition onto said fabric printable medium to form a printed image.

As will be appreciated by those skilled in the art, FIG. 1, FIG. 2 and FIG. 3 illustrate the relative positioning of the various layers of the printable media without necessarily illustrating the relative thicknesses of the various layers. It is to be understood that the thickness of the various layers is exaggerated for illustrative purposes. As illustrated in FIGS. 1, 2 and 3, the fabric printable medium (100) encompasses a fabric base substrate, also called supporting base substrate or bottom substrate (110), and several coating layers: a primary layer (120) and an image-receiving coating layer (130). The fabric printable medium has two surfaces: a first surface which might be referred to as the “image receiving side”, “image surface” or “image side” (101) when coated with the image-receiving layer and the primary layer, and a second surface, the opposite surface, which might be referred to as the “back surface” or “back-side” (102). The image receiving side is considered as the side where the image will be printed.

In some examples, such as illustrated in FIG. 1, the fabric printable medium (100) encompasses a fabric base substrate (110), a primary layer (120) and an image-receiving coating layer (130) applied only on the image-side (101) of the printable media (100).

In some other examples, such as illustrated in FIG. 2, the fabric printable medium (100) encompasses a fabric base substrate (110) with primary layers (120) that are applied on both sides (on the image and on the back-side) of the fabric printable medium (100). The image-receiving coating layer (130) is applied only on the image-side (101) of the printable media (100), over the primary layer (120). The back-side (102) is applied thus only with the primary layer (120).

In yet some other examples, such as illustrated in FIG. 3, the fabric printable medium (100) encompasses a fabric base substrate (110) with primary layers (120) that are applied on both sides (on the image and on the back-side) of the fabric printable medium (100). Image-receiving coating layers (130) are applied over both primary layer (120) on both sides of the printable media (100). In theory, both the image side and the back-side could thus be printed.

An example of a method (200) for forming a fabric printable medium in accordance with the principles described herein, by way of illustration and not limitation, is shown in FIG. 4. As illustrated in FIG. 4, such method encompasses providing (210) a fabric base substrate with an image-side and a back-side; providing (220) a flame-retardant dispersion including flame-retardant agents and polymeric dispersants; applying (230) a primary layer comprising polymeric binders and the flame-retardant dispersion on, at least, one side of the fabric base substrate; and applying (240) an image-receiving coating layer, comprising a first and a second crosslinked polymeric network, over, at least, a primary layer in order to obtain (250) the fabric printable medium.

An example of a printing method in accordance with the principles described herein, by way of illustration and not limitation, is shown in FIG. 5. FIG. 5 illustrates examples of the printing method (300) that encompasses: providing a fabric printable medium (310) as described herein, applying an ink composition onto said a printable medium (320) and obtaining a printed article (330).

The Fabric Base Substrate

A fabric printable medium (100) of the present disclosure, that can also be called herein printable recording media, is a media that comprises a fabric base substrate (110). The fabric base substrate (110) can also be called bottom supporting substrate or fabric substrate. The word “supporting” also refers to a physical objective of the substrate that is to carry the coatings layer and the image that is going to be printed.

Regarding such fabric base substrate, any textile, fabric material, fabric clothing, or other fabric product where there is a desire for application of printed matter can benefit from the principles described herein. More specifically, fabric substrates useful in present disclosure include substrates that have fibers that may be natural and/or synthetic. The term “fabric” as used to mean a textile, a cloth, a fabric material, fabric clothing, or another fabric product. The term “fabric structure” is intended to mean a structure having warp and weft that is one of woven, non-woven, knitted, tufted, crocheted, knotted, and pressured, for example. The terms “warp” and “weft” refers to weaving terms that have their ordinary means in the textile arts, as used herein, e.g., warp refers to lengthwise or longitudinal yarns on a loom, while weft refers to crosswise or transverse yarns on a loom.

It is notable that the term “fabric substrate” does not include materials commonly known as any kind of paper (even though paper can include multiple types of natural and synthetic fibers or mixture of both types of fibers). The paper thereon is defined as the felted sheet, roll and other physical forms that are made of various plant fibers (like trees or mixture of plant fibers) with synthetic fibers by laid down on a fine screen from a water suspension. Furthermore, fabric substrates include both textiles in its filament form, in the form of fabric material, or even in the form of fabric that has been crafted into finished article (clothing, blankets, tablecloths, napkins, bedding material, curtains, carpet, shoes, etc.). In some examples, the fabric base substrate has a woven, knitted, non-woven or tufted fabric structure.

In some examples, the fabric base substrate comprises wool, cotton, silk, linen, jute, flax, hemp, rayon, corn starch, tapioca, sugarcane, polyvinyl chloride, polyester, polyamide, polyimide, polyacrylic, polyacrylic polypropylene, polyethylene, polyurethane, polystyrene, polyaramid, polytetrafluoroethylene, polyethylene terephthalate, fiberglass, polytrimethylene, polycarbonate, polyester terephthalate, polybutylene terephthalate, or a combination thereof. In some other examples, the fabric base substrate is woven, knitted, non-woven or tufted and comprises natural or synthetic fibers selected from the group consisting of wool, cotton, silk, rayon, thermoplastic aliphatic polymers, polyesters, polyamides, polyimides, polypropylene, polyethylene, polystyrene, polytetrafluoroethylene, fiberglass, polycarbonates polytrimethylene terephthalate, polyethylene terephthalate and polybutylene terephthalate. In yet some other examples, the fabric base substrate is a synthetic polyester fiber.

In some examples, the fabric base substrate (110) has a basis weight that is ranging from about 50 gsm to about 400 gsm. In some other examples, the basis weight of the fabric substrate can range from about 100 gsm to about 300 gsm.

The fabric base substrate can be a woven fabric where warp yarns and weft yarns are mutually positioned at an angle of about 90°. This woven fabric includes, but is not limited to, fabric with a plain weave structure, fabric with twill weave structure where the twill weave produces diagonal lines on a face of the fabric, or a satin weave. The fabric base substrate can be a knitted fabric with a loop structure including one or both of warp-knit fabric and weft-knit fabric. The weft-knit fabric refers to loops of one row of fabric are formed from the same yarn. The warp-knit fabric refers to every loop in the fabric structure that is formed from a separate yarn mainly introduced in a longitudinal fabric direction. The fabric base substrate can also be a non-woven product, for example a flexible fabric that includes a plurality of fibers or filaments that are one or both of bonded together and interlocked together by a chemical treatment process (e.g., a solvent treatment), a mechanical treatment process (e.g., embossing), a thermal treatment process, or a combination of two or more of these processes.

The fabric base substrate can include one or both of natural fibers and synthetic fibers. Natural fibers that may be used include, but are not limited to, wool, cotton, silk, linen, jute, flax or hemp. Additional fibers that may be used include, but are not limited to, rayon fibers, or those of thermoplastic aliphatic polymeric fibers derived from renewable resources, including, but not limited to, cornstarch, tapioca products, or sugarcanes. These additional fibers can be referred to as “natural” fibers. In some examples, the fibers used in the fabric base substrate includes a combination of two or more from the above-listed natural fibers, a combination of any of the above-listed natural fibers with another natural fiber or with synthetic fiber, a mixture of two or more from the above-listed natural fibers, or a mixture of any thereof with another natural fiber or with synthetic fiber.

The synthetic fiber that may be used in the fabric base substrate can be a polymeric fiber including, but not limited to, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company), fiberglass, polytrimethylene, polycarbonate, polyethylene terephthalate or polybutylene terephthalate. In some examples, the fibers include a combination of two or more of the above-listed polymeric fibers, a combination of any of the above-listed polymeric fibers with another polymeric fiber or with natural fiber, a mixture of two or more of the above-listed polymeric fibers, or a mixture of any of the above-listed polymeric fibers with another polymer fiber or with natural fiber. In some examples, the synthetic fiber includes modified fibers from above-listed polymers. The term “modified fibers” refers to one or both of the polymeric fiber and the fabric as a whole having underwent a chemical or physical process such as, but not limited to, one or more of a copolymerization with monomers of other polymers, a chemical grafting reaction to contact a chemical functional group with one or both the polymeric fiber and a surface of the fabric, a plasma treatment, a solvent treatment, for example acid etching, and a biological treatment, for example an enzyme treatment or antimicrobial treatment to prevent biological degradation. The term “PVC-free” means no polyvinyl chloride (PVC) polymer or vinyl chloride monomer units in the substrate.

In some examples, the fabric base substrate contains both natural fiber and synthetic polymeric fiber. The amount of synthetic polymeric fibers can represent from about 20% to about 90% of the total amount of fiber. The amount of natural fibers can represent from about 10% to about 80% of amount of fiber.

The fabric base substrate may further contain additives including, but not limited to, one or more of colorant (e.g., pigments, dyes, tints), antistatic agents, brightening agents, nucleating agents, antioxidants, UV stabilizers, fillers and lubricants, for example. Alternatively, the fabric base substrate may be pre-treated in a solution containing the substances listed above before applying the coating composition. The additives and pre-treatments are included to improve various properties of the fabric.

The Flame-Retardant Dispersion

The fabric printable medium comprises a fabric base substrate; a primary layer containing polymeric binders applied on, at least, one side of the base substrate; and an image-receiving coating layer applied over, at least, one primary layer, comprising a first and a second crosslinked polymeric network. The primary layer comprises a flame-retardant dispersion. In some examples, both the primary layer and the image-receiving coating layer comprise a flame-retardant dispersion.

The flame-retardant dispersion comprises flame-retardant agents and polymeric dispersants. In some other examples, the flame-retardant dispersion comprises flame-retardant agents, polymeric dispersants and surfactant. In yet some examples, the flame-retardant dispersion comprises flame-retardant agents, polymeric dispersants and a synergist agent. And, in further examples, the flame-retardant dispersion comprises flame-retardant agents, polymeric dispersants, a synergist agent and surfactants. The flame-retardant dispersion may also contain other chemicals with different properties, such as suppression of flammability, good retention of white appearance, high thermal stability, good and/or UV stability.

As “flame-retardant”, or “fire-retardant”, it is meant herein any substance (i.e. agent) that inhibits or reduces flammability or delays their combustion of the substance (i.e. herein the media) containing it. In other word, the flame-retardant agent will have flame or fire retardancy properties. The flame-retardant agent can be in the forms of a water-dispersible slurry or in the form of solids particles with the different particle size and particle size distribution, with flame retardancy properties. The flame-retardant agent can include a mineral powder, an organo-halogenated compound, a polymeric brominated compound, a metal and phosphorus containing composition, a phosphorus containing composition, a nitrogen containing composition, a halogen, an organophosphate, or combination thereof. The flame-retardant agent particles with flame retardancy properties can be solid particles in the room temperature having flame retardancy properties. In other examples, the flame-retardant agent also refers to the solid powder package that include mixture of different chemical particles with different chemical structures but both having flame-retardancy properties. In some other examples, the flame-retardant agent can be a flame retardance package.

The “flame retardant agent package” or also called “flame retardance package” or “retardant agent” may comprise a solid particle compounds and a flame-retardant agent either in solid or liquid state in room temperature. One chemical may have higher flame retardance and another may have lower or limited flame retardancy properties, in one example, or has no capability of flame retardancy properties in another example.

The flame-retardant agents can be, for example, but not limited to, an organo-halogenated compound, a polymeric brominated compound, a metal oxide and phosphorus containing composition, a phosphorus and halogen containing composition, a phosphorus continuing composition, a nitrogen containing composition, a halogen, an organophosphate, or a combination thereof. In one example, the flame-retardant agents can include a mineral compound. Exemplary mineral compounds can include aluminum hydroxide, magnesium hydroxide, huntite (magnesium calcium carbonate), hydromangesite (hydrated magnesium carbonate), phosphorus, red phosphorus, boehmite (aluminum oxide hydroxide), boron compounds, or combinations thereof. In another example, the flame-retardant package can include either a liquid or a solid flame-retardant such as organo-halogenated compound. Exemplary organo-halogenated compounds can include organo-bromines, organochlorines, decabromo-diphenyl ether, decabromo-diphenyl ethane, and combinations thereof.

In some examples, the flame-retardant agent is a halogenated type of compound. The flame-retardant agent can be any halogenated chemicals which can act as a flame suppressant including substances with bromine, chlorine, phosphorous or any combination of these. In some other examples, the flame-retardant agent is a brominated type of compound. In yet some other examples, the flame-retardant agent is a brominated aromatic type of compound.

The flame-retardant agent can also include a polymeric brominated compound. Exemplary polymeric brominated compounds can include brominated polystyrenes, brominated carbonate oligomers, brominated epoxy oligomers, tetrabro-mophthalic anhydride, tetrabromo-bisphenol A, hexabromocyclododecane, chlorendic acid, ethers of chlorendic acid, chlorinated paraffins, and combinations thereof. In some other examples, the flame-retardant agent is an organic bromide compound such as 1,2-Bis(pentabromophenyl) ethane.

Example of flame-retardant agents can be brominated aromatic type of compound such as, for examples, 1,2-Bis(pentabromophenyl) ethane (CAS #84852-53-9); 3,3′,5,5′-Tetrabromobisphenol A (CAS #79-94-7); Ethylene-bis-tetrabromo-phthalimide (CAS #32588-76-4); or polybrominated diphenyl ethers such as Decabromodiphenyl ether (CAS #1163-19-5). Commercially available bromine-based flame-retardant agents include products with the tradenames: Greencrest® (available from Albemate), Saytex® 621, Saytex® 8010, Saytex® 8010zd, Saytex® Bt-93w, Saytex® Bt-93, Saytex® Cp-2000, Saytex® Hp-3010, Saytex® Hp-7010g, Saytex® Hp-7010p, Saytex® Rb-49, Saytex® Rb-7001, Saytex® Rb-79, Saytex® Rb-7980, Saytex® Rb-9170, Saytex® PURshield (all available from Albemate); Firemaster® 2100R, Firemaster® 550, Firemaster® 504, Firemaster® 508, Firemaster® 800, Firemaster® 520, Firemaster® 602, Firemaster® 600, Firemaster® 552, Firemaster® CP-44HF, Firemaster® PBS-64HW, Firemaster® BZ-54HP (all available from Chemtura Group).

In some examples, the flame-retardant agent is present, in the flame-retardant dispersion, in an amount representing from about 5 to about 98 wt % by total weigh of the flame-retardant dispersion. In some other examples, the flame-retardant agent is present, in the flame-retardant dispersion, in an amount representing from about 7 wt % to about 60 wt %, or from about 10 wt % to about 50 wt % by total flame-retardant dispersion.

The flame-retardant agent can include a metal and phosphorus containing composition. Example metal and phosphorus containing compositions can include aluminum diethylphosphinate, calcium diethylphosphinate, and combinations thereof. In a further example, the flame-retardant agent can include a phosphorus and a halogen containing composition. Exemplary phosphorus and halogen containing compositions can include tris(2,3-dibromopropyl) phosphate, chlorinated organophosphates, tris(1,3-dichloro-2-propyl) phosphate, tetrekis(2-chloroethyl) dicloro-isopentyldiphosphate, tris (1,3-dichloroisopropyl) phosphate, tris(2-chloroisopropyl) phosphate, and combinations thereof.

The flame-retardant agent can include a phosphorus containing composition. Exemplary phosphorus containing compositions can include phosphates, phosphonates, phoshpinates, and combinations thereof. In some examples, the phosphorus containing composition can have different oxidations states. In one example, the phosphorus containing composition can be a closed ring structure such as FR-102® (available from Shanghai Xusen Non-Halogen Smoke Suppressing Fire Retardants Co. Ltd, China) and Aflammit® (available from Thor, Germany).

In another example, the flame-retardant agent can include a nitrogen containing composition. Exemplary nitrogen containing compositions can include melamines, melamine derivatives, melamine, melamine cyanurate, melamine polyphosphate, melem (heptazine derivative), melon (heptazine derivative), and combinations.

In some examples, the flame-retardant agent can be a combination of a phosphorus containing compound, a nitrogen containing compound, and/or a halogen. In one example, the flame-retardant can include a phosphorus and a nitrogen containing composition. Exemplary phosphorus and nitrogen containing compositions can include ammonium polyphosphate (APP), poly 4,4-diaminodiphenyl methane spirocyclic pentaerythritol bisphosphonate (PDSPB), 1,4-di(diethoxy thiophosphamide benzene (DTPAB), and combinations. In another example, the flame-retardant agent can include an organophosphate. The organophosphate can include aliphatic phosphate; aliphatic phosphonate; aromatic phosphonate; aliphatic organophosphate; aromatic organophosphate; polymeric organophosphate with 2 or 3 oxygen atoms attached to the central phosphorus and combinations.

The flame-retardant dispersion includes flame-retardant agents and polymeric dispersants. The polymeric dispersing agent (also called polymeric dispersants) are used to disperse the flame-retardant agents into an aqueous mixture and, also, in order to decrease the rate of flocculation. The polymeric dispersants that are used herein may include statistically random copolymers, block copolymers, core shell polymeric structures, and grafted polymers or copolymers. Polymeric dispersing agents contain one or more functional moieties that anchor the polymer to the flame-retardant materials surface.

Functional moieties that may be used to anchor the polymer to the pigment are segments of aliphatic or aromatic moieties that will interact with flame-retardants of low surface energy. In some examples, the polymeric dispersant will also contain a second or multiple functional moieties which stabilizes the dispersion in aqueous mixtures.

Examples of polymeric dispersants that can be used in the flame-retardant dispersion are marketed under the trade names: Disperbyk® 190, Disperbyk® 191, Disperbyk® 2155, Disperbyk® 2025 (available from BYC) or TegoDispers® 760 W, and TegoDispers® 750 W (available from Evonik).

In some examples, the polymeric dispersants have an acrylate molecular structure with a molecular weight between 2,000 and 30,000 g/mol. The polymer can be built from reactive acrylic monomers that contain chemical groups that would increase the association between the polymer and the substance to be dispersed. In some other examples, the monomer units may contain reactive functional groups which may be modified post polymerizing to provide functional moieties which will interact with the pigment or promote dispersion stability.

The polymeric dispersants can also be silicone-based polymer dispersants, i.e. polymer with silicone backbone such as, for examples, branched silicone with graft polyglycerin chain or acryl polymer with graft silicone chain. Silicone-based polymer dispersants can, for examples, polyglyceryl-3 polydimethylsiloxyethyl dimethicone copolymer or acrylate/ethylhexyl acrylate/dimethicone methacrylate copolymer. Example of such silicone-based polymer dispersants are, for examples, KF-6106 or KP-578 from ShinEtsu.

In some examples, the polymeric dispersants are present, in the flame-retardant dispersion, in an amount representing from about 1 to about 20 wt % by total weigh of the flame-retardant dispersion. In some other examples, the polymeric dispersants are present, in the flame-retardant dispersion, in an amount representing from about 5 wt % to about 15 wt %, by total dry weight of the flame-retardant dispersions.

In some examples, the flame-retardant dispersion might contain a synergist that would supplement the halogen flame-retardant agent. When the synergist is present, the polymeric dispersant may also act as a dispersing agent to synergist. In some examples, a second dispersant may be used to disperse the synergist additive (which may be combined in the first dispersion or mixed separately, and the dispersions are then combined afterward).

The synergist can be any inorganic or organic additives that work as synergist or that supplement the halogen flame-retardant. An example of an inorganic synergist that may be used to enhance halogen flame-retardant's is Antimony (III) oxide (CAS #1309-64-4). Other inorganic additives with flame-retardant properties that may supplement the halogenated flame-retardants effectiveness can include mineral compounds such as aluminum hydroxide, magnesium hydroxide, huntite (magnesium calcium carbonate), hydromangesite (hydrated magnesium carbonate), boehmite (aluminum oxide hydroxide). In other examples, organic compounds containing phosphorous or boron additives may be used to supplement the fire-retardant properties of halogens.

In some other examples, additives may be used to aid in the flame-retardant dispersion processing and mixing. In addition to the polymeric dispersing agent, the dispersion may contain a low molecular weight wetting, or dispersing agent which might have a faster association rate to quickly wet insoluble or moderately soluble components and thereby aid in dispersing the fire-retardant components and additives. Exemplary low molecular weight wetting and dispersing agents that can be used are alkyl sulfosuccinate salts such as Dioctyl sulfosuccinate sodium salt (CAS #577-11-7). Examples of commercially available sulfosuccinate salts are included in products with the trade name Aerosol®, as well as Triton® GR-5M, Triton® GR-7M, Triton® GR-7ME available from Dow chemical.

In some examples, the flame-retardant dispersion contains surfactants. In some other examples, the flame-retardant dispersion contains low molecular weight surfactants or wetting agents, or oligomers. As low molecular weight surfactants, it is meant herein surfactants with a molecular weight which is below 1500 g/mol. low molecular weight surfactants will not be synthesized from a polymerization process (i.e. low molecular weight surfactants are not built from repeating monomer units).

Such low molecular weight surfactants are available under the tradename Tegowet® (available from Evonik), Dowfax® (available from Dow Chemical), and/or Dynwet® (available from BYC). One example of suitable surfactant can be anionic surfactants such as an alkyldiphenyloxide disulfonate (e.g., Dowfax® 8390 and Dowfax® 2A1 from The Dow Chemical Company).

The flame-retardant dispersion might also contain, in yet some other examples, an anti-foaming agent that could reduce foam formation resulting from mixing and air entrapment within the dispersion. Exemplary anti-foaming agents, which may be included, can be marketed under the trade names of Foamaster® MO2185 and BYK-018. Further examples may include additives that have both wetting and anti-foam properties such as products available under the trademark Surfynol (from Air product).

The Image-Receiving Layer (130)

The fabric printable medium (100) of the present disclosure includes an image-receiving layer (130). The image-receiving layer (130), or inkjet receiving layer, will form a coating layer and is applied over the primary layer (120) on the image-side of the fabric printable media. Such layer would act as the image-receiving layer since, during the printing process, the ink will be directly deposited on its surface. In one example, the image-receiving layer is applied over the primer layer on the image-side of the media. In another example, the image-receiving layer is applied over the primer layer on both the image-side and the back-side of the media.

In some examples, the image-receiving coating composition is applied to the primary layer at a coat-weight ranging from about 0.1 to about 40 gsm (gram per square meter) or at a coat-weight ranging or from about 1 to 20 gsm (gram per square meter) or at a coat-weight ranging or from about 2 to 10 gsm (gram per square meter). In some other examples, the image-receiving coating composition is applied to the primary layer at a thickness ranging from about 1 μm to about 50 μm with a dry coat-weight ranging from about 1 gsm to about 20 gsm.

The image-receiving layer comprises a first and a second crosslinked polymeric network. The image-receiving layer can further comprise a flame-retardant dispersion as defined above. When present, the flame-retardant dispersion contained in the image-receiving layer will be identical or different from the flame-retardant dispersion present in the primary layer. In some examples, the flame-retardant dispersions that are present in for the both the primary layer and the image receiving coating layer will be identical (i.e. have same chemical nature).

When present, the flame-retardant dispersion is present, in the image-receiving layer composition, in an amount representing from about 1 to about 70 wt % by total weigh of the image-receiving layer composition. In some other examples, the flame-retardant dispersion can be present, in the image-receiving layer composition, in an amount representing from about 10 wt % to about 50 wt %, by total dry weight of the image-receiving layer composition.

The image-receiving layer (130) comprises a first crosslinked polymeric network and a second crosslinked polymeric network. The wording “polymer network” refers herein to a polymer and/or a polymer mixture which can be self-cross-linked, by reaction of different function groups in the same molecular chain, or inter-cross-linked by reaction with another compound which has different function group. In some other examples, the image-receiving layer includes a first and a second polymeric network. In yet some other examples, the image-receiving layer includes a first and a second polymeric network that are crosslinked polymeric network. The first crosslinked polymeric network and the second crosslinked polymeric network can be either different or identical by their chemical natures. The image-receiving layer can further comprise filler particles. The filler particles can be inorganic filler particles, organic particles, particles with or without flame retardancy nature, and flame-retardants.

In some examples, the first crosslinked polymeric network can be crosslinked to itself. In another example, the first crosslinked polymeric network can be crosslinked to itself and to the second crosslinked polymeric network. In one example, the second crosslinked polymeric network can be crosslinked to itself. When the first crosslinked polymeric network and the second crosslinked polymeric network are not crosslinked to one another they can be entangled or appear layered onto one another.

The first and second crosslinked polymeric networks can be present in the image-receiving layer in a variety of amounts. The first and second crosslinked polymeric networks can collectively represent from about 60 wt % to about 99 wt % of the total weight of the image-receiving layer. In another example, the first and second crosslinked polymeric networks can collectively represent from about 70 wt % to about 95 wt % of the total weight of the image-receiving layer. In a further example, the first and second crosslinked polymeric networks can collectively range from about 85 wt % to about 93 wt % of the total weight of the image-receiving layer. In some examples, the first and second crosslinked polymeric networks can be present in equal amounts. In other examples, the first and second crosslinked polymeric networks can be present in different amounts.

In some examples, in the image-receiving coating composition, the first crosslinked polymeric network and the second crosslinked polymeric network are different and independently comprises polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, a derivative thereof, or a combination thereof. The first and/or the second crosslinked polymeric networks can include a polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivative thereof, or combination thereof. In some examples, the first and second crosslinked polymeric networks can be different polymers.

In one example, the first and/or the second crosslinked polymeric network can include a polyacrylate based polymer. Exemplary polyacrylate based polymers can include polymers made by hydrophobic addition monomers include, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethyl acrylate, hydroxyethylmethacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), and combinations thereof. Polymers made from the polymerization and/or copolymerization of alkyl acrylate, alkyl methacrylate, vinyl esters, and styrene derivatives may also be useful. In one example, the polyacrylate based polymer can include polymers having a glass transition temperature greater than 20° C. In another example, the polyacrylate based polymer can include polymers having a glass transition temperature of greater than 40° C. In yet another example, the polyacrylate based polymer can include polymers having a glass transition temperature of greater than 50° C.

In some examples, the first and/or the second crosslinked polymeric network can be formed by using self-cross-linked polyurethane polymers or cross-linkable polyglycidyl or polyoxirane resins. In some other examples, the first and/or second crosslinked polymeric network can be formed by using self-cross-linked polyurethane polymers. The self-cross-linked polyurethane polymer can be formed by reacting an isocyanate with a polyol. Exemplary isocyanates used to form the polyurethane polymer can include toluene-diisocyanate, 1,6-hexamethylenediisocyanate, diphenyl-methanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, and combinations thereof. Commercially available isocyanates can include Rhodocoat® WT 2102 (available from Rhodia AG, Germany), Basonat® LR 8878 (available from BASF Corporation, N. America), Desmodur® DA, and Bayhydur® 3100 (Desmodur® and Bayhydur® are available from Bayer AG, Germany). In some examples, the isocyanate can be protected from water. Exemplary polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclo-hexane-dimethanol; 1,2,3-propanetriol; 2-ethyl-2-hydroxymethyl-1,3-propanediol; and combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Exemplary poly-isocyanates can include diisocyanate monomers and oligomers. The self-cross-linked polyurethane polymer can also be formed by reacting an isocyanate with a polyol, where both isocyanates and polyols have average less than three end functional groups per molecule so that the polymeric network is based on a liner polymeric chain structure.

The polyurethane chain can have a trimethyloxysiloxane group and cross-link action can take place by hydrolysis of the function group to form silsesquioxane structure. The polyurethane chain can also have an acrylic function group, and the cross-link structure can be formed by nucleophilic addition to acrylate group through aceto-acetoxy functionality. In some other examples, the first and/or second crosslinked polymeric network is formed by using vinyl-urethane hybrid copolymers or acrylic-urethane hybrid polymers. In yet some other examples, the polymeric network includes an aliphatic polyurethane-acrylic hybrid polymer. Representative commercially available examples of the chemicals which can form a polymeric network include, but are not limited to, NeoPac® R-9000, R-9699 and R-9030 (from Zeneca Resins), Sancure® AU4010 (from Lubrizol) and Hybridur® 570 (from Air Products).

In one example, the weight average molecular weight of the polyurethane polymer used in the first and/or second crosslinked polymer can range from about 20,000 Mw to about 200,000 Mw as measured by gel permeation chromatography. In another example, the weight average molecular weight of the polyurethane polymer can range from about 40,000 Mw to about 180,000 Mw as measured by gel permeation chromatography. In yet another example, the weight average molecular weight of the polyurethane polymer can range from about 60,000 Mw to about 140,000 Mw as measured by gel permeation chromatography.

Exemplary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; and combinations thereof (These polyurethanes are available from Alberdingk Boley Inc., North Carolina, USA).

The polymeric network (the first and/or second) can include a polymeric core that is, at least, one polyurethane. The polyurethanes include aliphatic as well as aromatic polyurethanes. The polyurethane is typically the reaction products of the following components: a polyisocyanate having at least two isocyanate functionalities (—NCO) per molecule with, at least, one isocyanate reactive group such as a polyol having at least two hydroxy groups or an amine. Suitable poly-isocyanates include diisocyanate monomers, and oligomers. Examples of polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. In some other, the polyurethanes are aromatic polyether polyurethanes, aliphatic polyether polyurethanes, aromatic polyester polyurethanes, and aliphatic polyester polyurethanes. Representative commercially available examples of polyurethanes include Sancure® 2710 and/or Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517®, Sancure® 1591, Sancure® 2255, Sancure® 2260, Sancure® 2310, Sancure® 2725, and Sancure® 2016 (all commercially available from Lubrizol Inc.).

Other examples of commercially-available polyurethanes can include NeoPac® R-9000, R-9699, and R-9030 (available from Zeneca Resins, Ohio), Printrite® DP376 and Sancure® AU4010 (available from Lubrizol Advanced Materials, Inc., Ohio), and Hybridur® 570 (available from Air Products and Chemicals Inc., Pennsylvania).

In some example, the polymeric network is created by using cross-linkable polyglycidyl or polyoxirane resins. Cross-link reaction can take place either with themselves (through catalytic homopolymerisation of oxirane function group) or with the help of a wide range of co-reactants including polyfunctional amines, acids, acid anhydrides, phenols, alcohols, and thiols. Both polyglycidyl resin and co-reactants are compatible with the chemicals that form a polymeric network before curing in liquid state. The term “compatible” refers here to the fact that there is no significant phase separation after mixing in the room temperature.

In some examples, the first and/or the second polymeric network comprises epoxy-functional additives. Epoxy-functional additives can include alkyl and aromatic epoxy resins or epoxy-functional resins, such as for example, epoxy novolac resin(s) and other epoxy resin derivatives. Epoxy-functional molecules can include at least one, or two or more pendant epoxy moieties. The molecules can be aliphatic or aromatic, linear, branched, cyclic or acyclic. If cyclic structures are present, they may be linked to other cyclic structures by single bonds, linking moieties, bridge structures, pyro moieties, and the like. Examples of suitable epoxy functional resins are commercially available and include, without limitation, Ancarez® AR555 (commercially available from Air Products), Ancarez® AR550, Epi-rez® 3510W60, Epi-rez® 3515W6, or Epi-rez® 3522W60 (commercially available from Hexion).

In some other examples, the polymeric network includes epoxy resin. Examples of suitable aqueous dispersions of epoxy resin include Waterpoxy® 1422 (commercially available from Cognis) or Ancarez® AR555 1422 (commercially available from Air Products). The polymeric network can comprise epoxy resin hardeners. The examples of epoxy resin hardeners that can be used herein include liquid aliphatic or cycloaliphatic amine hardeners of various molecular weights, in 100% solids or in emulsion or water and solvent solution forms. Amine adducts with alcohols and phenols or emulsifiers can also be envisioned. Examples of suitable commercially available hardeners include Anquawhite® 100 (from Air Products) and EPI-CURE® 8290-Y-60 (from Hexion). The polymeric network can include water-based polyamine as epoxy resin hardeners. Such epoxy resin hardeners can be, for examples, water-based polyfunctional amines, acids, acid anhydrides, phenols, alcohols and/or thiols. Other examples of commercially available polymeric networks that can be used herein includes the ingredients Araldite® PZ 3921 and/or Aradur® 3985 available from Huntsman.

In some examples, the image-receiving layer includes a first and/or second polymeric network that is a hybrid network created by using self-cross-linked polyurethane polymers and by using cross-linkable polyglycidyl or polyoxirane resins. In some other examples, the image-receiving layer comprises a polymeric network that is created by using vinyl-urethane hybrid copolymers or acrylic-urethane hybrid polymers and water-based epoxy resins and water-based polyamines. In a further example, the first and/or second crosslinked polymeric network can include a styrene maleic anhydride (SMA). In one example, the SMA can include NovaCote 2000® (Georgia-Pacific Chemicals LLC, Georgia). In another example, the styrene maleic anhydride can be combined with an amine terminated polyethylene oxide (PEO); amine terminated polypropylene oxide (PPO), copolymer thereof, or a combination thereof. In one example, combining a styrene maleic anhydride with an amine terminated PEO and/or PPO can strengthen the polymeric network by crosslinking the acid carboxylate functionalities of the SMA to the amine moieties on the amine terminated PEO and/or PPO. The amine terminated PEO and/or PPO, in one example, can include amine moieties at one or both ends of the PEO and/or PPO chain, and/or as branched side chains on the PEO and/or PPO. In one example, utilizing an amine terminated PEO and/or PPO in combination with a SMA can allow for the user to retain the glossy features of the SMA while eliminating the brittle nature of SMA. Exemplary commercially available amine terminated PEO and/or PPO compounds can include Jeffamine® XTJ-500, Jeffamine® XTJ-502, and Jeffamine® XTJ D-2000 (all available from Huntsman International LLC, Texas). In some examples, a weight ratio of SMA to the amine terminated PEO and/or PPO can range from about 100:1 to about 2.5:1. In another, a weight ratio of the SMA to the amine terminated PEO and/or PPO can range from about 90:1 to about 10:1. In yet another example, a weight ratio of the SMA to the amine terminated PEO and/or PPO can range from about 75:1 to about 25:1.

The Primary Layer

The fabric printable medium of the present disclosure comprises a fabric base substrate (110); a primary layer (120) and an image-receiving coating composition (130). The primary layer (120) is applied directly on, at least, one side of the fabric base substrate (i.e. the image side). In some examples, the primary layer is applied on both the image-side and the back-side of the media on fabric base substrate.

In one example, the primary layer (120) can be applied to the fabric base substrate at a dry coat-weight ranging from about 1 gsm to about 80 gsm per side. In one other example, the primary layer (120) is applied, to the fabric substrate, at a dry coat-weight ranging from about 5 gsm to about 60 gsm. In yet another example, the primary layer (120) is applied, to the fabric substrate, at a dry coat-weight ranging from about 10 gsm to about 40 gsm.

The primary layer comprises a flame-retardant dispersion, as defined above, comprising flame-retardant agents and polymeric dispersants.

The primary layer composition includes a polymeric binder and a flame-retardant dispersion. Other functional additives can be added to the primary layer coating composition, for specific property control such as, for examples, surfactant for wettability, and processing control agent such as defoamer, and PH control base/acid buffer.

In some examples, the flame-retardant dispersion is present, in the primary layer composition, in an amount representing from about 5 to about 85 wt % by total weigh of the primary layer composition. In some other examples, the flame-retardant dispersion is present, in the primary layer composition, in an amount representing from about 10 wt % to about 70 wt %, by total dry weight of the primary layer composition. In yet some other examples, the flame-retardant dispersion is present, in the primary layer composition, in an amount representing from about 15 wt % to about 55 wt %, by total dry weight of the primary layer composition.

The primary layer composition contains a polymeric binder. Without being linked by any theory, it is believed that the polymeric binder can provide binding function to the fillers to form a continuous layer and adhesion function between coating layers and the fabric substrate. The polymeric binder can be present, in the primary layer composition, in an amount ranging from about 5 wt % to about 70 wt % by total weigh of the primary layer composition.

The polymeric binder can be either water a soluble, a synthetic or a natural substance or an aqueous dispersible substance like polymeric latex. In some other examples, the polymeric binder is polymeric latex. The polymeric binder can be a water-soluble polymer or water dispersible polymeric latex. In some examples, the polymeric binder has a glass transition temperature (Tg) that is less than 5° C. Indeed, it is believed that polymeric binder with higher glass transition temperature (Tg) might contribute to a stiff coating and can damage the fabric “hand feeling” of the printing media. In some examples, the polymeric binders have a glass transition temperature (Tg) ranging from −40° C. to 0° C. In some other examples, the polymeric binders have a glass transition temperature (Tg) ranging from −20° C. to −5° C. The way of measuring the glass transition temperature (Tg) parameter is described in, for example, Polymer Handbook, 3rd Edition, authored by J. Brandrup, edited by E. H. Immergut, Wiley-Interscience, 1989.

In some examples, the polymeric binders are crossed-linked binder. “Crossed-linked binder” refers to the fact that multiple polymer substances with reactive function groups can react with each other to form a between-molecular chain structure, a cross linker, a macro-molecular substance or a low molecular weight chemical with more than two function groups that can be used. Binders with “self-crosslink” capability can mean that macro-molecular chains have different reactive function groups that can be used. The cross-linked binders can balance both softness and mechanical strength of the coating layers.

Suitable polymeric binders include, but are not limited to, water-soluble polymers such as polyvinyl alcohol, starch derivatives, gelatin, cellulose derivatives, acrylamide polymers, and water dispersible polymers such as acrylic polymers or copolymers, vinyl acetate latex, polyesters, vinylidene chloride latex, styrene-butadiene or acrylonitrile-butadiene copolymers. Non-limitative examples of suitable binders include styrene butadiene copolymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, and combinations thereof. In some examples, the binder is a polymer or a copolymer selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers and acrylonitrile-butadiene polymers or copolymers. In a further example, the polymeric binder can include an acrylonitrile-butadiene latex.

In some other examples, the binder component is a latex containing particles of a vinyl acetate-based polymer, an acrylic polymer, a styrene polymer, an SBR-based polymer, a polyester-based polymer, a vinyl chloride-based polymer, or the like. In yet some other examples, the binder is a polymer or a copolymer selected from the group consisting of acrylic polymers, vinyl-acrylic copolymers and acrylic-polyurethane copolymers. Such binders can be polyvinylalcohol or copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. Examples of binders include, but are not limited to, polyvinyl alcohols and water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combination thereof. In some examples, the binder is carboxylated styrene-butadiene copolymer binder. Such binder can be find commercially under the tradename Genflow® and Acrygen® from Omnova Solutions.

In one example, the polymeric binder may have an average molecular weight (Mw) of about 5,000 to about 200,000. In another example, the average molecular weight of the polymeric binder can vary from 10,000 Mw to about 200,000 Mw. In yet another example, the average molecular weight of the polymeric binder can vary from 20,000 Mw to 100,000 Mw. In a further example, the average molecular weight of the polymeric binder can vary from 100,000 Mw to 200,000 Mw. In one example, the polymeric binder can have a weight average molecular weight from 5,000 Mw to 200,000 Mw and can include polystyrene-butadiene emulsion, acrylonitrile butadiene latex, starch, gelatin, casein, soy protein polymer, carboxy-methyl cellulose, hydroxyethyl cellulose, acrylic emulsion, vinyl acetate emulsion, vinylidene chloride emulsion, polyester emulsion, polyvinyl pyrroilidene, polyvinyl alcohol, styrene butadiene emulsions, or combination thereof.

In some examples, the polymeric binder is a self-crosslinking aqueous acrylic dispersion such an Edolan® AB available from Tanatex Chemicals (having a solids content of 45% and Tg of −18° C.).

Method for Forming a Fabric Printable Medium

The fabric printable medium is prepared by using several surface treatment compositions herein named a coating layer or coating composition. In some examples, as illustrated in FIG. 4, the method (200) for forming the fabric printable medium encompasses: providing (210) a fabric base substrate with an image-side and a back-side (i.e. with a first and a second side); providing (220) a flame-retardant dispersion including flame-retardant agents and polymeric dispersants; applying (230) a primary layer comprising polymeric binders and the flame-retardant dispersion on, at least, one side of the fabric base substrate; and applying (240) an image-receiving coating layer comprising a first and a second crosslinked polymeric network over, at least, one primary layer in order to obtain (250) the fabric printable medium.

In some examples, the primary layer is applied on both side of the fabric base substrate. In some other examples, the image-receiving coating layer is applied over the primary layer on both side of the fabric base substrate.

The flame-retardant dispersion, including flame-retardant agents and polymeric dispersants, is used as a stand-alone element of the coatings composition of the media, which means thus that the flame-retardant dispersion is pre-mixed into a well dispersed “component” and de-gassed, and then mixed into the image receiving layer and primary layer. Without being linked by any theory, it is believed that any attempt of mixing individual components into the coating composition will results un-desirable defects such as air bubbles, de-wetting, or FR acumination.

The application of the image-receiving coating layer and the primary can be done by any coating process and can include a floating knife process, a knife on roll mechanism process, or a transfer coating process. The floating knife process can include stretching the fabric to form an even uniform surface. The floating knife process can further include transporting the fabric under a stationary knife blade. In some examples, the step of applying the coating layers can include applying a foam coating. The foam coating can be applied using a knife-on-the roll mechanism. The knife-on-the roll mechanism can be followed by passing the fabric through calendaring pressure nips. The calendaring can be done either in room temperature or at an elevated temperature and/or pressure. The elevated temperature can range from 40° C. to 100° C. The elevated pressure can range from about 100 psi to about 5,000 psi. In some other examples, the coating process can include transferring the coating composition. When the coating composition is transferred, the coating can be spread onto a release substrate to form a film. The film can then be laminated onto the fabric.

The primary layer (120) and the image-receiving coating layer (130) can be dried using any drying method in the arts such as box hot air dryer. The dryer can be a single unit or could be in a serial of 3 to 7 units so that a temperature profile can be created with initial higher temperature (to remove excessive water) and mild temperature in end units (to ensure completely drying with a final moisture level of less than 1-5% for example). The peak dryer temperature can be programmed into a profile with higher temperature at begging of the drying when wet moisture is high and reduced to lower temperature when web becoming dry. The dryer temperature is controlled to a temperature of less than about 200° C. to avoid yellowing textile, and the fabric web temperature is controlled in the range of about 90 to about 180° C. In some examples, the operation speed of the coating/drying line is 20 to 30 meters per minute.

Printing Method

Once the coating compositions are applied to the fabric base substrate and appropriately dried, ink compositions can be applied by any processes onto the fabric printable medium. In some examples, the ink composition is applied to the fabric printable medium via inkjet printing techniques. As illustrated in FIG. 5, the printing method (300) encompasses obtaining (310) a fabric printable medium, with an image-side and a back-side, comprising a fabric base substrate, obtaining a fabric printable medium, with an image-side and a back-side, comprising a fabric base substrate; a primary layer containing polymeric binders and a flame-retardant dispersion including flame-retardant agents and polymeric dispersants applied on, at least, one side of the base substrate and an image-receiving coating layer, applied over, at least, one primary layer, comprising a first and a second crosslinked polymeric network; and, then, applying (320) an ink composition onto said fabric printable medium to form a printed image. Said printed image will have, for instance, enhanced image quality and image permanence. In some examples, when needed, the printed image can be dried using any drying device attached to a printer such as, for instance, an IR heater.

In some examples, the ink composition is an inkjet ink composition that contains one or more colorants that impart the desired color to the printed message and a liquid vehicle. As used herein, “colorant” includes dyes, pigments, and/or other particulates that may be suspended or dissolved in an ink vehicle. The colorant can be present in the ink composition in an amount required to produce the desired contrast and readability. In some examples, the ink compositions include pigments as colorants. Pigments that can be used include self-dispersed pigments and non-self-dispersed pigments. Any pigment can be used; suitable pigments include black pigments, white pigments, cyan pigments, magenta pigments, yellow pigments, or the like. Pigments can be organic or inorganic particles as well known in the art. As used herein, “liquid vehicle” is defined to include any liquid composition that is used to carry colorants, including pigments, to a substrate. A wide variety of liquid vehicle components may be used and include, as examples, water or any kind of solvents.

In some other examples, the ink composition, applied to the fabric printable medium, is an ink composition containing latex components. Latex components are, for examples, polymeric latex particulates. The ink composition may contain polymeric latex particulates in an amount representing from about 0.5 wt % to about 15 wt % based on the total weight of the ink composition. The polymeric latex refers herein to a stable dispersion of polymeric micro-particles dispersed in the aqueous vehicle of the ink. The polymeric latex can be natural latex or synthetic latex. Synthetic latexes are usually produced by emulsion polymerization using a variety of initiators, surfactants and monomers. In various examples, the polymeric latex can be cationic, anionic, nonionic, or amphoteric polymeric latex. Monomers that are often used to make synthetic latexes include ethyl acrylate; ethyl methacrylate; benzyl acrylate; benzyl methacrylate; propyl acrylate; methyl methacrylate, propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxypropyhiethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; butyl acrylate; iso-butyl methacrylate; 2-ethylhexyl acrylate; 2-ethylhexyl methacrylate; isooctyl acrylate; and iso-octyl methacrylate.

In some examples, the latexes are prepared by latex emulsion polymerization and have an average molecular weight ranging from about 10,000 Mw to about 5,000,000 Mw. The polymeric latex can be selected from the group consisting of acrylic polymers or copolymers, vinyl acetate polymers or copolymers, polyester polymers or copolymers, vinylidene chloride polymers or copolymers, butadiene polymers or copolymers, polystyrene polymers or copolymers, styrene-butadiene polymers or copolymers and acrylonitrile-butadiene polymers or copolymers. The latex components are on the form of a polymeric latex liquid suspension. Such polymeric latex liquid suspension can contain a liquid (such as water and/or other liquids) and polymeric latex particulates having a size ranging from about 20 nm to about 500 nm or ranging from about 100 nm to about 300 nm.

### EXAMPLES

The raw materials and chemical components used in the illustrating samples are listed in Table 1.

TABLE 1

| Ingredients | Nature of the ingredients | Supplier |
|---|---|---|
| Araldite® PZ 3901 | Cross-linked polymeric network | Hundtsman Inc. |
| Aradur® 3985 | Cross-linked polymeric network | Hundtsman Inc. |
| Byk-Dynwet® 800 | silicone-free wetting agent | BYK Inc. |
| Sancure® 2026 | Polyurethane polymer | Lubrizol Inc. |
| Sancure® AU4010 | Self-Crosslinking aliphatic polyurethane-acrylic network | Lubrizol Inc. |
| Foamaster® MO2185 | De-foamer | BASF Co. |
| Genflow® 3000 | carboxylated styrene-butadiene copolymer binder | Omnova Solutions |
| Tegowet® 510 | Surfactant | Evonik Industries |
| Saytex® BT-93 | Halogenated Flame-retardant | Albemarle |
| Antimony | synergist | |
| Aerosol® OT-70 | Wetting and leveling agent | Dow chemical |
| Tamol ® SN | dispersants | Dow chemical |
| TegoDispers®760W | polymeric dispersants | Evonik |

### Example 1—Preparation of Printable Medium Samples and Flame-Retardant Dispersion

Different media were made using the different fire-retardant dispersion formulations. The illustrating media samples 1 and 2 are fabric print medium in accordance with the principles described herein. Samples 3 and 4 are comparative examples. The media sample structures are illustrated in Table 2. Each sample has a support base structure (110) which is a 100% woven polyester fabric (with plain weave) having a weight of 130 gsm and thickness of 175 micrometers (μm), an image-receiving coating layer (130) and a primary layer (120).

TABLE 2

| | | | |
|---|---|---|---|
| Media | Image-receiving coating layer (130) | Primary layer (120) | base structure (110) |
| sample 1 | Image-receiving layer with FR | Primary layer with FR | 100 % woven polyester fabric |
| | dispersion Exp. 1 | dispersion Exp. 1 | |
| sample 2 | Image-receiving layer with FR | Primary layer with FR | 100 % woven |
| | dispersion Exp. 2 | dispersion Exp. 2 | polyester fabric |
| sample 3 | Image-receiving layer with FR | Primary layer with FR | 100 % woven |
| (comp.) | dispersion Exp. 3 | dispersion Exp. 3 | polyester fabric |
| sample 4 | Image-receiving layer with FR | Primary layer with FR | 100 % woven |
| (comp.) | dispersion Exp. 4 | dispersion Exp. 4 | polyester fabric |

The formulation of the image-receiving coating layer (130) and of the primary layer (120) are illustrated in Table 3 below. Each coating compositions include a flame-retardant dispersion (FR dispersion).

TABLE 3

| | |
|---|---|
| Ingredient | Amount (Parts by dry weight) |

Image-receiving coating layer (130)

| | |
|---|---|
| Byk-Dynwet® 800 | 0.8 |
| Araldite® PZ 3901 | 5 |
| Aradur® 3985 | 5 |
| Sancure® 2016 | 6 |
| Sancure® 4010 | 5 |
| FR dispersion | 30 |
| Foamaster | 0.6 |

Primary layer (120)

| | |
|---|---|
| Byk-Dynwet® 800 | 0.8 |
| Genflow® 3000 | 50 |
| FR dispersion | 36 |

The different formulations of the flame-retardant dispersion (FR dispersion), that are part of the image-receiving coating layer and of the primary layer, are illustrated in Table 4. Each flame-retardant dispersion formulations have solids content of about 60%. Exp. 1 and Exp. 2 are flame-retardant dispersions according to the present disclosure. Exp. 3 and Exp. 4 are comparative examples.

TABLE 4

| | | Exp. 2 | Exp. 3 (comp.) | Exp. 4 (comp.) |
|---|---|---|---|---|
| Chemical | Exp. 1 (by dry weight) | (by dry weight) | (by dry weight) | (by dry weight) |
| Saytex® BT-93 | 61.5 | 52 | 64 | 61.5 |
| Antimony | 30 | 26 | 31 | 30 |
| Aerosol® OT-70 | 0.25 | — | | |
| Tamol® SN | | | 4 | |
| Foamaster® | 0.25 | | 1 | |
| TegoDispers®760W | 8 | 22 | | |
| Tegowet®510 | | | | 2 |
| Total Dry Parts | 100 | 100 | 100 | 91.5 |

The different fire-retardant dispersion formulations are evaluated: the sedimentation rate, the viscosity and the maximum particle size are measured. The sedimentation rate is measured in a 5 ml syringe and by measuring the change in height of the precipitate over time. The viscosity is measured using a Brookfield DV1 digital viscometer. The particle size is determined using a Hegman gauge. The sedimentation rate is determined over 4 hours (a low viscosity with a low dispersion rate indicates a dispersion with superior stability). A dispersion 5 (Exp. 5) is made by mixing all components, same as Exp. 1, directly into the image receiving coating and primary coating, without forming a stand-alone pre-dispersed dispersion. For Exp. 4 and 5, the mixing did not generate a dispersion, it was thus impossible to measure the sedimentation rate. All results of the fire-retardant dispersion are illustrated in Table 5.

TABLE 5

| | Dispersion | Dispersion | | |
|---|---|---|---|---|
| | Sedimentation Rate | Viscosity | Max Particle size | |
| Exp. 1 | 0.8 mm/hr | 25 cp | 5-15 | μM |
| Exp. 2 | 0.25 mm/hr | 100 cp | 5-15 | μM |
| Exp. 3 (comp.) | >3 mm/hr | >1000 cp | >50 | μM |
| Exp. 4 (comp.) | N/A | >1000 cp | >100 | μM |
| Exp. 5 (comp) | NA | >1000 cp | >100 | μM |

### Example 2—Samples Performances

The same images are printed on the experimental media samples 1 and 2 and Comparison Samples 3 and 4 using a HP® DesignJet L360 Printer equipped with HP 789 ink cartridge (HP Inc.). The printer is set with a heating zone temperature at about 50° C., a cure zone temperature at about 110° C., and an air flow at about 15%. The printed fabric mediums are evaluated for different performances: image quality, image durability and Flame-resistance and Flame-resistance particles on the surface. The results of these tests are expressed in the Table 6 below.

TABLE 6

| | Image Quality | | | Image Durability | | | | | | |
|---|---|---|---|---|---|---|---|---|---|---|
| | | ink | | ink | coin | rub. | wrinkle | folding | FR | Fire |
| | Gamut | bleed | Gloss | transfer | scratch | res. | res. | res. | particles | retardancy |
| Sample 1 | 533K | 5 | 3 | 5 | 3 | 5 | 3 | 4 | 5 | pass |
| Sample 2 | 548K | 5 | 3 | 5 | 3.5 | 5 | 3 | 4 | 5 | pass |
| Sample 3 | 525K | 5 | 4 | 5 | 4 | 5 | 4 | 4 | 2 | pass |
| Sample 4 | 541K | 5 | 2 | 5 | 3.5 | 5 | 2 | 4 | 1 | fail |

Image quality is evaluated using both numeric measurement method and visual evaluation method. The image quality of the prints is measured with Gamut, Ink bleed and image gloss test. The Ink bleed and Ink gloss are evaluated visually from the printed samples using a scale of 1-5 (with 1 being the worst and 5 being the best). Gamut Measurement represents the amount of color space covered by the ink on the media sample (a measure of color richness). The gamut is measured on Macbeth® TD904 (Micro Precision Test Equipment, California) (A higher value indicates better color richness). The image gloss is evaluated using spectrophotometer (such as the X-Rite i1/i0) and single-angle gloss-meter (such as the BYK Gloss-meter).

Image Durability is with rub resistance, coin scratch, wrinkle resistance, folding resistance and ink transfer tests. Rub resistance testing is carried out using an abrasion scrub tester (per ASTM D4828 method): fabrics are printed with small patches of all available colors (cyan, magenta, yellow, black, green, red, and blue). A weight of 250 g is loaded on the test header. The test tip is made of acrylic resin with crock cloth. The test cycle speed is 25 cm/min and 5 cycles are carried out for each sample at an 8-inch length for each cycle. The test probe is in dry (dry rub) or wet (wet rub) mode. Coin scratch test is performed by exposing the various samples to be tested to a 45-degree coin scratching under a normal force of 800 g. The test is done in a BYK Abrasion Tester (from BYK-Gardner USA, Columbus, Md.) with a linear, back-and-forth action, attempting to scratch off the image-side of the samples (5 cycles). The image durability is evaluated visually from the printed samples using a scale of 1-5 (with 1 being the worst and 5 being the best).

Fire retardancy performance is evaluated by Diversified Test Lab Inc., complying with FR NFPA 701 standard and is also evaluated by Hewlett Packard's internal test with CA 1237 standard. The printed samples are either failing or passing the test. The flame-retardant (FR) particles that are present on the surface of the media are evaluated by visual inspection with a LASCO light.

1) A fabric printable medium, with an image-side and a back-side, comprising:
a. a fabric base substrate;
b. a primary layer containing polymeric binders applied on, at least, one side of the base substrate; and
c. an image-receiving coating layer applied over, at least, one primary layer comprising a first and a second crosslinked polymeric network;
wherein the primary layer comprises a flame-retardant dispersion including flame-retardant agents and polymeric dispersants.

2) The fabric printable medium of claim 1 wherein both the primary layer and the image-receiving coating layer comprise the flame-retardant dispersion including flame-retardant agents and polymeric dispersants.

3) The fabric printable medium of claim 1 wherein both the image-side and the back-side of printable medium comprise a primary layer and an image-receiving coating layer.

4) The fabric printable medium of claim 1 wherein, in the flame-retardant dispersion, the fire-retardant agents are halogenated compounds.

5) The fabric printable medium of claim 1 wherein, in the flame-retardant dispersion, the fire-retardant agents are brominated type of compounds.

6) The fabric printable medium of claim 1 wherein, in the flame-retardant dispersion, the polymeric dispersants have an acrylate molecular structure with a molecular weight between 2,000 and 30,000 g/mol.

7) The fabric printable medium of claim 1 wherein the flame-retardant dispersion, further comprises a synergist agent.

8) The fabric printable medium of claim 1 wherein the flame-retardant dispersion, further comprises low molecular weight surfactants.

9) The fabric printable medium of claim 1 wherein the fire-retardant agents is present in the flame-retardant dispersion, in an amount representing from about 5 to about 98 wt % by total weigh of the flame-retardant dispersion.

10) The fabric printable medium of claim 1 wherein the polymeric dispersants is present in the flame-retardant dispersion, in an amount representing from about 1 to about 20 wt % by total weigh of the flame-retardant dispersion.

11) The fabric printable medium of claim 1 wherein, in the primary layer, the polymeric binder is a polymer, or a copolymer, selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers and acrylonitrile-butadiene polymers or copolymers.

12) The fabric printable medium of claim 1 wherein, in the image-receiving coating composition, the first crosslinked polymeric network and the second crosslinked polymeric network are different and independently comprises polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, a derivative thereof, or a combination thereof.

13) The fabric printable medium of claim 1 wherein, in the image-receiving coating composition, the first and second crosslinked polymeric networks can collectively represent from about 60 wt % to about 99 wt % of the total weight of the image-receiving layer.

14) A method for forming a fabric printable medium comprising:
a. providing a fabric base substrate with an image-side and a back-side;
b. providing a flame-retardant dispersion including flame-retardant agents and polymeric dispersants;
c. applying a primary layer comprising polymeric binders and the flame-retardant dispersion on, at least, one side of the fabric base substrate; and
d. applying an image-receiving coating layer, comprising a first and a second crosslinked polymeric network, over, at least, a primary layer.

15) A printing method comprising:
a. obtaining a fabric printable medium, with an image-side and a back-side, comprising a fabric base substrate; a primary layer containing polymeric binders and a flame-retardant dispersion including flame-retardant agents and polymeric dispersants applied on, at least, one side of the base substrate; an image-receiving coating layer, applied over, at least, one primary layer, comprising a first and a second crosslinked polymeric network;
b. and applying an ink composition onto said fabric printable medium to form a printed image.
